(19) United States
(12) Patent Application Publication
(10) Pub. No.: US 2005/0072481 A1
(43) Pub. Date: Apr. 7, 2005

(54) Manifold valve

(76) Inventors: Toshihiro Hanada, Miyazaki (JP); Takeshi Hamada, Nobeoka-shi Miyazaki (JP)

Correspondence Address: BURNS DOANE SWECKER & MATHIS L L P, POST OFFICE BOX 1404, ALEXANDRIA, VA, 22313-1404, US

(21) Appl. No.: 10/497,527

(22) PCT Filed: Dec. 5, 2002
(86) PCT No.: PCT/JP02/12765

(30) Foreign Application Priority Data
Dec. 6, 2001 (JP) 2001-373128
Dec. 12, 2001 (JP) 2001-378901

(51) Int. Cl. F17D 1/00

(52) U.S. Cl. 137/884

(57) ABSTRACT

A manifold valve according to the present invention includes a main body (1) and actuators (2, 3) each having a valve body (46, 47). The main body is formed with at least one set of a main flow passage-side valve chamber (17) and a secondary flow passage-side valve chamber (19) which are in communication with each other through a connecting flow passage (11), a branched flow passage (9) communicating with the main flow passage-side valve chamber, a-main flow passage (6) communicating with the main flow passage-side valve chamber through a main flow passage-side communication port (13) opening at a center of a bottom of the main flow passage-side valve chamber, and a secondary flow passage (7) communicating with the secondary flow passage-side valve chamber through a secondary flow passage-side communication port (15) opening at a center of a bottom of the secondary flow passage-side valve chamber. The main flow passage-side communication port and the secondary flow passage-side communication port are opened and closed by valve bodies (46, 47) of the actuators, respectively. Further, the connecting flow passage and the branched flow passage are structured such that bottoms thereof are substantially flush with those of the main flow passage-side valve chamber and the secondary flow passage-side valve chamber.

### TECHNICAL FIELD

The present invention relates to a manifold valve having a main flow passage, a secondary flow passage and a branch flow passage and, more particularly, to a manifold valve which achieves a compact size and an exceptional cleaning effect.

### BACKGROUND ART

Conventionally, in a line, which is branched from a main flow passage of a slurry line, in the semiconductor industry, or from various chemical liquid lines and supplies a fluid, there has been often provided a line (a secondary flow passage) for cleaning the branched line, for the purpose of preventing from occurrence of trouble such as the aggregation or fixation of the slurry or the deposition of crystals or the like. Generally, there have been adopted a method of incorporating three-way valves 200, 201, two-way valves 202, 203 and T-shaped pipes 204, 205 with a main flow passage 206, secondary flow passages 207, 208 and branched flow passages 209, 210, as shown in FIG. 18, or a method of incorporating three-way valves 211, 212 and four-way valves 213, 214 with a main flow passage 215, a secondary flow passage 216 and branched flow passages 217, 218, as shown in FIG. 19.

However, in the former method shown in FIG. 18, there are caused a problem in that a slurry stagnates in the flow passage portions from the T-shaped pipes 204, 205 to the two-way valves 202, 203, respectively, and a problem in that the flow passage portions from the three-way valves 200, 201 to the T-shaped pipes 204. 205, respectively, are not sufficiently cleaned. Also, in the latter method shown in FIG. 19, there is caused another problem in that the space required for piping is increased as the number of the branched flow passages increases and, therefore, the number of the valves increases, resulting in an increased cost.

### DISCLOSURE OF THE INVENTION

Accordingly, an object of the present invention is to provide a manifold valve which achieves a compact size and an exceptional cleaning effect.

According to the present invention, there is provided a manifold valve which includes: a main body; actuators each having a valve body; the main body formed with at least one set of a main flow passage-side valve chamber and a secondary flow passage-side valve chamber which are in communication with each other through a connecting flow passage, a branched flow passage communicating with the main flow passage-side valve chamber, a main flow passage communicating with the main flow passage-side valve chamber through a main flow passage-side communication port opening at a center of a bottom of the main flow passage-side valve chamber, and a secondary flow passage communicating with the secondary flow passage-side valve chamber through a secondary flow passage-side communication port opening at a center of a bottom of the secondary flow passage-side valve chamber; the main flow passage-side communication port and the secondary flow passage-side communication port being opened and closed by the valve bodies of the actuators, respectively; and the connecting flow passage and the branched flow passage being structured such that bottoms thereof are substantially flush with the bottoms of the main flow passage-side valve chamber and the secondary flow passage-side valve chamber.

Preferably, the manifold valve is formed with a plurality of main flow passage-side valve chambers, which communicate with the same main flow passage through respective main flow passage-side communication ports.

Preferably, the manifold valve is formed with a plurality of secondary flow passage-side valve chambers, which communicate with the same secondary flow passage or different secondary flow passages through respective secondary flow passage-side communication ports thereof.

In the above-mentioned manifold valve, the main flow passage may extend parallel to or perpendicular to the secondary flow passage.

The main flow passage may extend through said main body. Alternatively, it may not extend through the main body or, in other words, it may open, at one end thereof, to outside and may terminate, at the other end thereof, in the interior of the main body.

Similarly, the secondary flow passage may extend through the main body. Alternatively, it may not open, at one end thereof, to outside and may terminate, at the other end thereof, in the interior of the main body.

### BRIEF DESCRIPTION OF THE DRAWINGS

The above and other objects, features and advantages of the present invention will be described below in more detail on the basis of preferred embodiments of the present invention with reference to the accompanying drawings, wherein:

FIG. 1 is a plan view illustrating only a main body of a manifold valve according to a first embodiment of the present invention;

FIG. 2 is a longitudinal sectional view of the main body taken along a line II-II of FIG. 1 with four actuators fixed to the main body, illustrating the condition in which a main flow passage-side communication port is opened and a secondary flow passage-side communication port is closed;

FIG. 3 is a longitudinal sectional view of the main body taken along a line III-III of FIG. 1 with four actuators fixed to the main body, illustrating the condition in which both of two main flow passage-side communication ports are opened;

FIG. 4 is a longitudinal sectional view of the main body taken along a line IV-IV of FIG. 1 with four actuators fixed to the main body, illustrating the condition in which a main flow passage-side communication port is opened and a secondary flow passage-side communication port is closed;

FIG. 5 is a longitudinal sectional view of the actuator;

FIG. 6 is a three-dimensional perspective view of the main body shown in FIG. 1;

FIG. 7 is a plan view illustrating only a main body of a manifold valve according to a second embodiment of the present invention;

FIG. 8 is a plan view illustrating only a main body of a manifold valve according to a third embodiment of the present invention;

FIGS. 9A to 9F are external appearance views illustrating a flow of fluid in respective combinations of opening and closing of the respective communication ports in the manifold valve according to the first embodiment of the present invention;

FIG. 10 is an external appearance view illustrating a branched chemical liquid supply line using the manifold valve according to the first embodiment of the present invention;

FIG. 11 is a plan view illustrating only a main body of a manifold valve according to a fourth embodiment of the present invention;

FIG. 12 is a longitudinal sectional view of the main body taken along a line XII-XII of FIG. 11 with four actuators fixed to the main body, illustrating the condition in which a main flow passage-side communication port is opened and a secondary flow passage-side communication port is closed;

FIG. 13 is a three-dimensional perspective view of the main body shown in FIG. 11;

FIG. 14 is a three-dimensional perspective view illustrating only a main body of a manifold valve according to a fifth embodiment of the present invention;

FIG. 15 is a plan view illustrating only a main body of a manifold valve according to a sixth embodiment of the present invention;

FIGS. 16A to 16F are external appearance views illustrating flows of fluid in respective combinations of opening and closing of the respective communication ports in manifold valve according to the fourth embodiment of the present invention;

FIG. 17 is an external appearance view illustrating a branched chemical liquid supply line using the manifold valve according to the fourth embodiment of the present invention;

FIG. 18 is an external appearance view illustrating a prior art branched chemical liquid supply line using three-way valves, two-way valves and T-shaped pipes; and

FIG. 19 is an external appearance view illustrating another prior art branched chemical liquid supply line using three-way valves and four-way valves.

### BEST MODE FOR CARRYING OUT THE INVENTION

While the preferred embodiments of the present invention will be described below with reference to the attached drawings, the present invention should not, of course, be limited thereto.

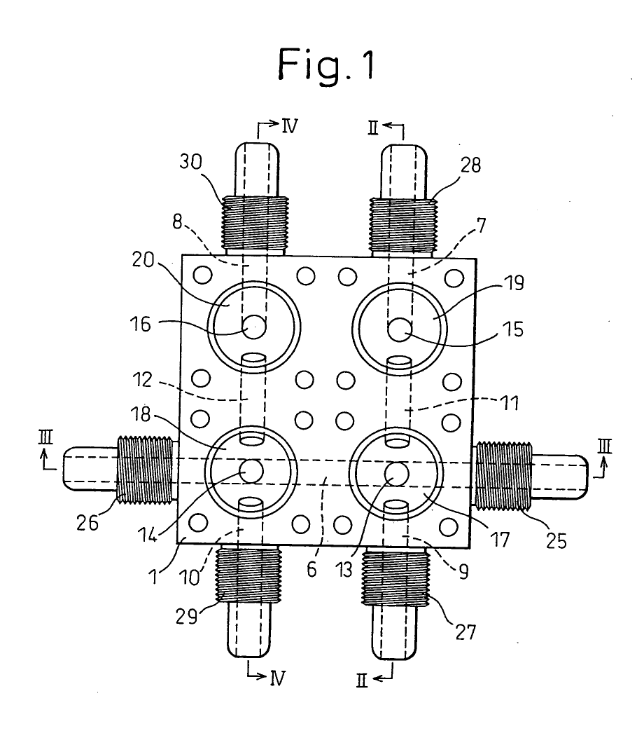

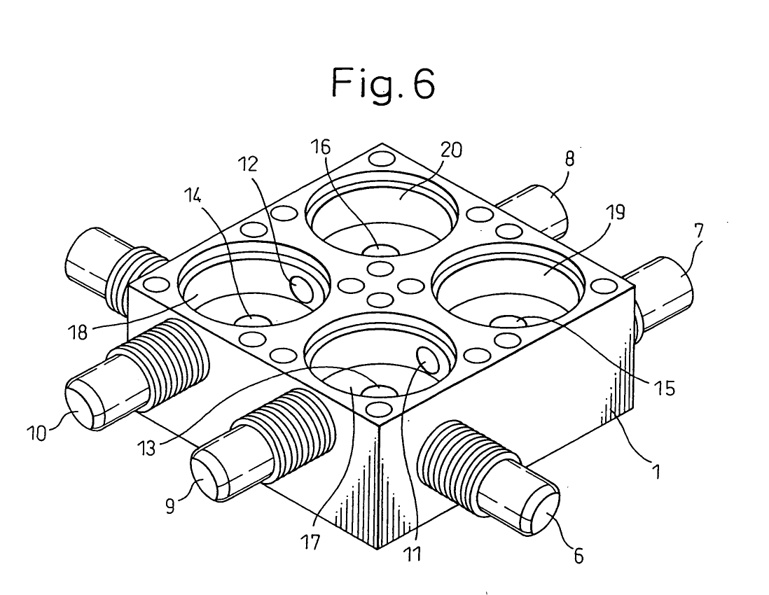

With reference to FIGS. 1 to 6, a manifold valve according to the present invention includes a main body 1, a main flow passage 6, a secondary flow passage 7 and a branched flow passage 9. The main body is formed in an upper portion thereof with a cylindrical main flow passage-side valve chamber 17 and a secondary flow passage-side valve chamber 19 which are in communication with each other through a connecting flow passage 11. The main flow passage 6 is in communication with a main flow passage communication port 13 formed at a center of a bottom of the main flow passage-side valve chamber 17 and extends through the whole of the main body 1 as shown in FIGS. 1 and 6. The secondary flow passage 7 is in vertical communication with a secondary flow passage-side communication port 15 formed at a center of a bottom of the secondary flow passage-side valve chamber 19. The branched flow passage 9 is in communication with the main flow passage-side valve chamber 17 and is located on a side of the main body 1 opposite to the secondary flow passage 7. The connecting flow passage 11 is structured such that a bottom thereof is substantially flush with the bottoms of the main flow passage-side valve chamber 17 and the secondary flow passage-side valve chamber 19, while the branched flow passage 9 is also structured such that a bottom thereof is substantially flush with the bottom of the main flow passage-side valve chamber 17. Thus, a structure is obtained which prevents a portion likely to stagnate the fluid from appearing in the main flow passage-side valve chamber 17 and the secondary flow passage-side valve chamber 19.

As apparent from FIGS. 1 to 5, the main flow passage 6 extends in a direction perpendicularly intersecting each of the secondary flow passage 7, the branched flow passage 9 and the connecting flow passage 11. In other words, the secondary flow passage 7, the branched flow passage 9 and the connecting passage are parallel to each other and extend in the same direction.

Also, the edges of openings or the peripheral portions of the main flow passage-side communication port 13 and the secondary flow passage-side communication port 15 constitute valve seats 21, 22 which valve bodies 46, 47 of the actuators 2, 3 are pressed against or are separated from. The main flow passage-side valve chamber 17 is formed to have a diameter larger than those of the main flow passage-side communication port 13 and the valve body 46, and, similarly, the secondary flow passage-side valve chamber 19 is formed to have a diameter larger than those of the secondary flow passage-side communication port 15 and the valve body 47.

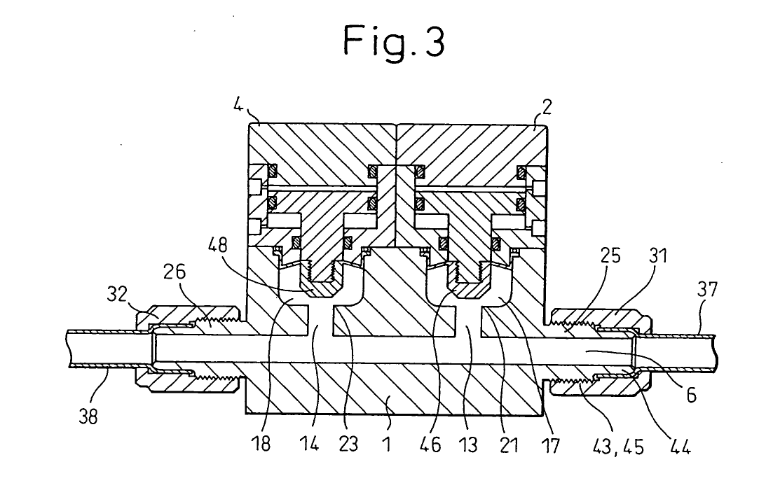

Another main flow passage-side communication port 14 different from the main flow passage-side communication port 13 is formed at a different position along the main flow passage 6 (see FIG. 3). There is also formed, in the main flow passage-side communication port 14, a main flow passage-side valve chamber 18, a branched flow passage 10, a connecting flow passage 12, a secondary flow passage-side valve chamber 20, a secondary flow passage-side communication port 16 and a secondary flow passage 8, which are in the same relationship as that between the main flow passage communication port 13, the main flow passage-side valve chamber 17, the branched flow passage 9, the connecting flow passage 11, the secondary flow passage-side communication port 15 and the secondary flow passage 7. In other words, in this embodiment, four valve chambers are formed in the main body 1 (see FIGS. 1 and 6).

While two main flow passage-side communication ports 13 and 14 are formed in the main flow passage 6 according to this embodiment, this is not limitative but three or more main flow passage-side communication ports may be formed in the main flow passage 6 with the same design as described above, for any purpose, to increase the number of valve chambers.

Also, while the secondary flow passage, the branched flow passage and the connecting flow passage have the same diameter as that of the main flow passage in the drawings used for the description of this embodiment, the diameters, of course, may be changed for any purpose.

In this embodiment, coupling portions 25 and 26 are formed to project from lateral surfaces of the main body 1, through which the main flow passage 6 extends. The secondary flow passages 7, 8 and the branched flow passages 9, 10, are also formed to have similar structures (see FIG. 1). The connection of a piping tube 37 to the coupling portion 25 is achieved by first fitting the piping tube 37 to a forward end 44 of the coupling portion 25 and then screwing a female thread portion 45 of a cap nut 31 on a male thread portion 43 provided on the outer peripheral surface of the coupling portion 25 to clamp and securing an end of the piping tube 37 between them (see FIG. 3). Piping tubes 38 to 42 are also connected to other coupling portions 26 to 30, respectively, in the same manner as described above. As for the configuration for connecting the piping tubes 37 to 42 to the main body 1, it is not limited to this embodiment but any other typical connecting configuration may be adopted.

The actuators 2 to 5 are fixed to the upper portion of the main body 1 by through bolts and nuts (not shown). As the constitutions of the actuators are the same, the actuator 2 will be described as a representative (see FIG. 5).

In FIG. 5, a cylindrical body, which is designated by reference numeral “50”, has a cylindrical cylinder portion 54 in the interior thereof, a columnar protrusion 55 on the lower surface thereof, and a through-hole 56 formed to extend from a center of a bottom of the cylinder portion 54 through the protrusion 55. An O-ring 69 is fitted on the inner peripheral surface of the through-hole 56. Further, a pair of working fluid supply ports 64, 65, which are in communication with the upper and lower portions of the cylinder portion 54, respectively, are formed on the lateral surface of the cylindrical body 50.

A cylinder cap, which is designated by reference numeral “51”, is provided at a bottom thereof with a columnar protrusion 57 having an O-ring 67 fitted thereto and is secured to the cylindrical body 50 by fitting the columnar protrusion 57 into the upper portion of the cylinder portion 54 with the O-ring 67 placed between them. In this embodiment, the main body 1, the cylindrical body 50 and the cylinder cap 51 are secured to each other as a unit by through bolts and nuts (not shown).

A piston, which is designated by reference numeral “52”, has an O-ring 68 fitted to the outer peripheral surface thereof, and is fitted into the cylinder portion 54 of the cylindrical body 50 with the O-ring 68 placed between them so as to slidably move upward and downward. A rod portion 58 is integral with the piston 52 at a center of the lower end surface thereof so as to extend through a through hole 56 of the cylindrical body 50 in a slidable manner, and a joining portion 59 to which a valve body 46 of a diaphragm 53 is joined is provided at a forward end of the rod portion 58. Also, an upper space 62 is defined by the upper surface of the piston 52, the inner peripheral surface of the cylinder portion 54 and the lower surface of the cylinder cap 51, while a lower space 63 is defined by the lower surface of the piston 52, the outer peripheral surface of the rod portion 58, and the inner peripheral surface and the bottom surface of the cylinder portion 54.

The diaphragm 53 is integrally provided at a center of the lower surface thereof with the valve body 46, which is pressed against or separated from the valve seat 21 (i.e., the opening edge of the main flow passage-side communication port 13) formed on the main body 1. The valve body 46 is joined to the forward end of the rod portion 58 of the piston 52 by screwing. A cylindrical membrane portion 60 is provided along the outer peripheral edge of the diaphragm 53, and an annular projection 61 is provided along the outer periphery of the upper end of the cylindrical membrane portion 60. The cylindrical membrane portion 60 is clamped by the inner peripheral surface of the main flow passage-side valve chamber 17 of the main body 1 and the outer peripheral surface of the protrusion 55 of the cylindrical body 50. Also, the annular projection 61 is inserted into a stepped portion 66 formed in the upper portion of the inner peripheral surface of the main flow passage-side valve chamber 16 with an O-ring 70 placed between the cylindrical body 50 and the annular projection 61, and is clamped and secured by the inner peripheral surface of the main flow passage-side valve chamber 17 and the outer peripheral surface of the protrusion 55 of the cylindrical body. A configuration of the diaphragm 53 should not be limited to that disclosed in this embodiment and thus any other type of diaphragm having a membrane portion clamped by the main body 1 and the cylindrical body 50, such as a bellows type diaphragm, may be used.

Also, as for the construction of the actuator, a construction having a spring in the interior thereof or a manually operable type construction may be used as long as the actuator has valve bodies for opening and closing the main flow passage-side communication port and the secondary flow passage-side communication port, respectively, and thus it is not particularly limited to that disclosed in this embodiment. Further, although it is preferable to separately provide the actuators having these valve bodies on the side of the main flow passage and on the side of the secondary flow passage, the actuators may be provided integrally and the arrangement thereof is not limited to a particular one.

The members used in the present invention, such as a main body or others, are preferably made of fluorocarbon resin, such as polytetrafluoroethylene (hereinafter referred to as PTFE) or tetrafluoroethylene-perfluoroalkylvinylether copolymer (hereinafter referred to as PFA), since fluorocarbon resin has a superior chemical resistance characteristics and elutes less impurities. However, other plastics, such as polyvinylchlorlde or polypropylene, or even metal may be used, and thus the materials for the main body, etc., are not especially limited. Also, fluorocarbon resin, such as PTFE or PFA, is preferably used as a material for the diaphragm. However, rubber or metal may be used, and the material is not especially limited.

Next, the operation of the manifold valve according to the first embodiment of the present invention shown in FIG. 1 will be described below.

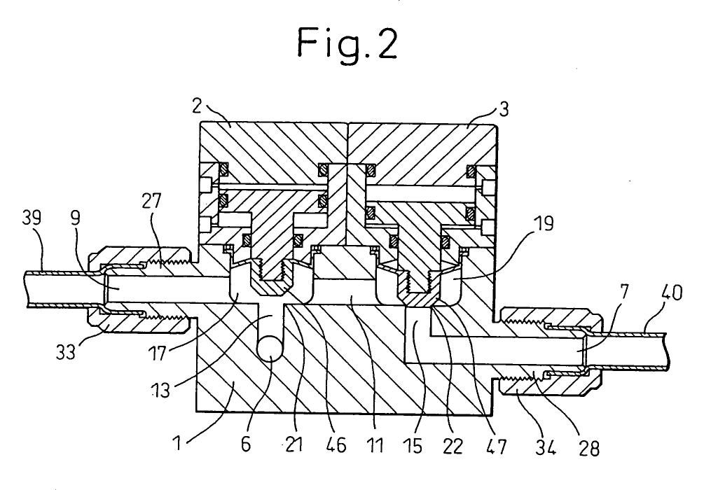

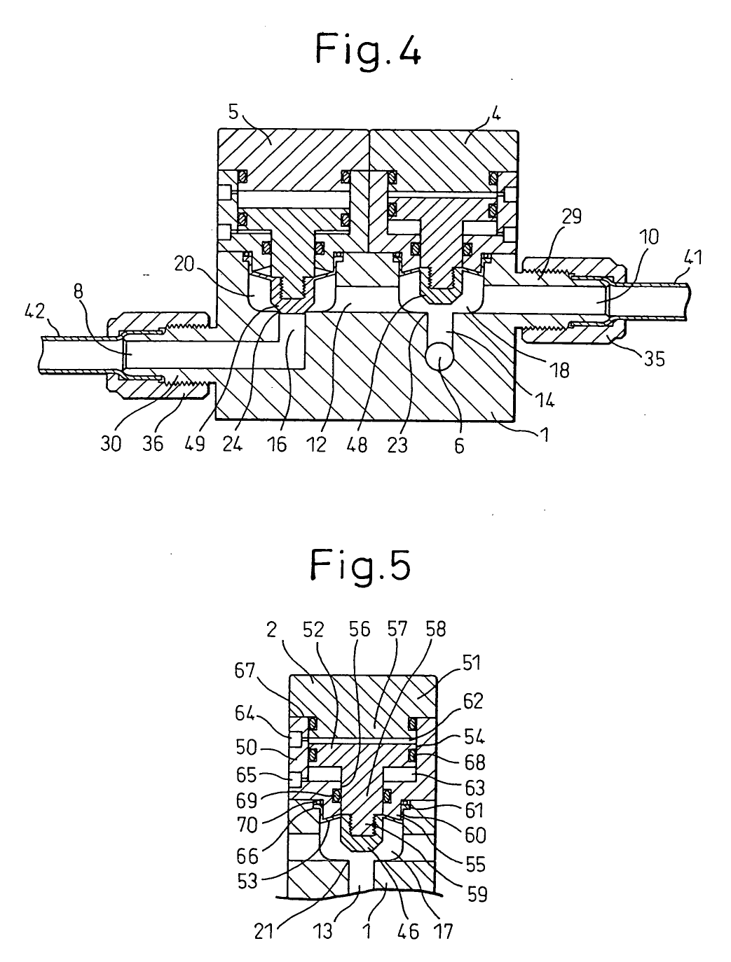

FIGS. 2 and 3 illustrate the condition in which the main flow passage-side communication port 13 is opened and the secondary flow passage-side communication port 15 is closed. In this condition, the fluid in the main flow passage 6 flows to the secondary flow passage-side valve chamber 19, the connecting flow passage 11, the main flow passage-side valve chamber 17 and the branched flow passage 9. When the working fluid (for example, a compressed air etc.) is supplied from the outside through the working fluid supply port 64 of the actuator 2 shown in FIG. 5 into the upper space 62 in this condition, the piston 52 is pushed down by the pressure of the working fluid, so that the valve body 46 connected to the lower end of the rod portion 58 is pressed against the valve seat 21 to close the main flow passage-side communication port 13. On the other hand, when the working fluid is supplied to the lower space 63 from the working fluid supply port 65 of the actuator 3, the piston 52 is pushed up by the pressure of the working fluid, so that the valve body 47 connected to the lower end of the rod portion 58 is separated away from the valve seat 22 to open the secondary flow passage communication port 15 and to allow the fluid in the secondary flow passage 7 to flow into the secondary flow passage-side valve chamber 19, the connecting flow passage 11, the main flow passage-side valve chamber 17 and the branched flow passage 9. (As the working fluid supply port, the lower space, the piston and the rod portion of the actuator 3 are the same as those of the actuator 2, the same reference numerals as those of the actuator 2 are used for designating them.) The opening and closing operations of the main flow passage-side communication port 14 and the secondary flow passage-side communication port 16 shown in FIG. 4 are carried out in the same manner as described above.

For example, when the valve according to this embodiment is used in a line for supplying a slurry from the main flow passage 6 side and the cleaning liquid from the secondary flow passages 7 and 8 side and discharging them from the branched flow passages 9 and 10, the slurry flowing in the main flow passage 6 flows through the main flow passage-side valve chambers 17, 18 and is discharged from the branched flow passages 9 and 10 in the condition shown in FIGS. 2, 3 and 4, but the slurry is still stagnating in the connecting flow passages 11, 12 and the secondary flow passage-side valve chambers 19, 20. However, if the cleaning liquid is made to flow from the secondary flow passages 7, 8 by closing the main flow passage-side communication ports 13, 14 and opening the secondary flow passage-side communication ports 15, 16 in this condition, the stagnating slurry is discharged from the branched flow passages 9, 10 so that the interior of the valve can be cleaned. In this embodiment, as the bottom surfaces of the branched flow passages 9, 10, the main flow passage-side valve chambers 17, 18, the connecting flow passages 11, 12 and the secondary flow passage-side valve chambers 19, 20 are designed to be substantially flush with each other as described above, the volume of the manifold valve in which the fluid may stagnate becomes as small as possible. Also, as the respective flow passages are formed in a straight line, the pressure loss is low. Therefore, an exceptional cleaning effect can be obtained.

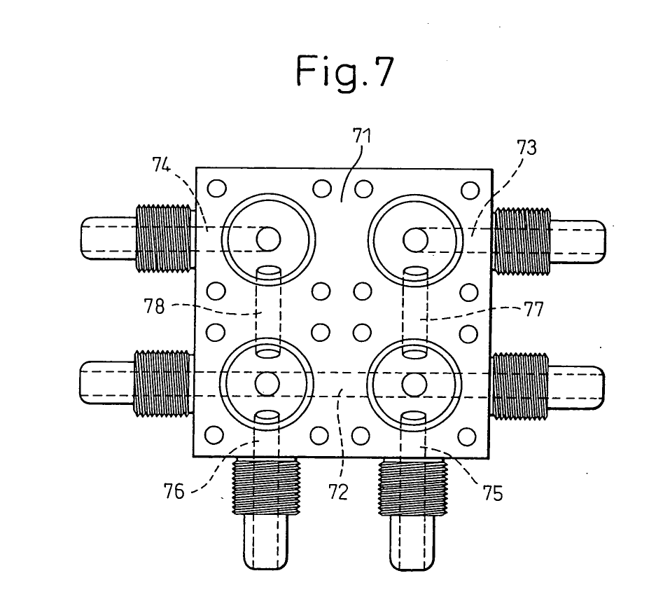

FIG. 7 is a plan view illustrating only a main body 71 of a manifold valve according to a second embodiment of the present invention. The difference thereof from the first embodiment is that secondary flow passages 73, 74 at opposite end of the main body extend parallel to a main flow passage 72 and are opened on a lateral surface of the main body 71 on which the main flow passage 72 is opened. The other constructions, such as branched flow passages 75, 76, are the same as in the manifold valve of the first embodiment, and, therefore, a description thereof will be omitted. Also, the operation of the second embodiment is the same as in the first embodiment except that the flow direction of the fluid flowing in the secondary flow passages 73, 74 is only changed to a direction perpendicular to the connecting flow passages 77, 78, and, therefore, the description of the operation thereof will be omitted.

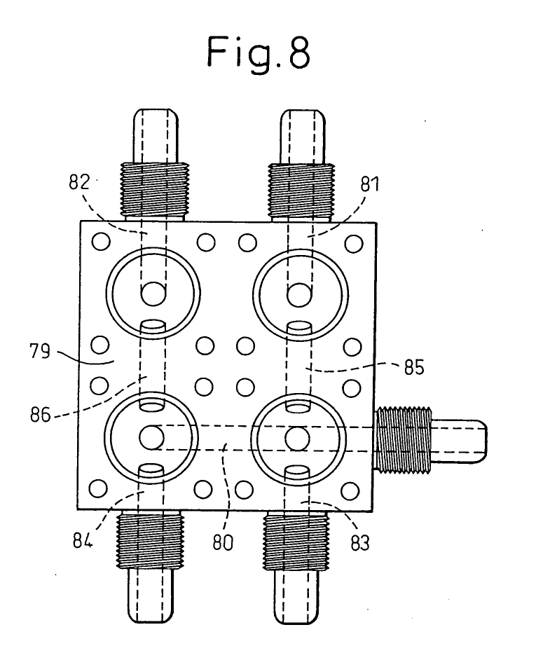

FIG. 8 is a plan view illustrating only a main body 79 of a manifold valve according to a third embodiment of the present invention. The difference thereof from the first embodiment is that a main flow passage 80 does not extend through a main body 79 but opens only on one lateral surface of the main body 79, i.e., one end of the main flow passage 80 opens to the outside of the main body 79, while the other end thereof terminates in the interior of the main body 79. The other constructions such as secondary flow passages 81, 82, branched flow passages 83, 84 or connecting flow passages 85, 86 are the same as in the manifold valve according to the first embodiment and, therefore, the description thereof will be omitted. Also, the operation of the second embodiment is the same as in the first embodiment and, therefore, a description thereof will be omitted.

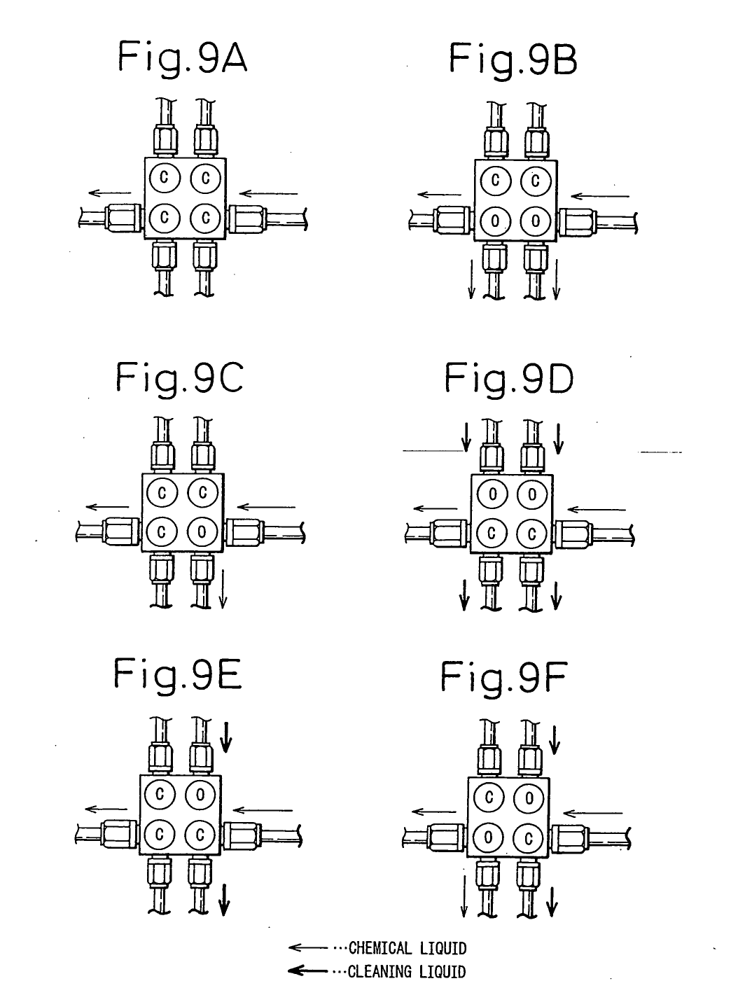

FIGS. 9A to 9F illustrate a representative flow of fluid in the respective combinations of opening and closing of the respective communication ports in the manifold valve, wherein the manifold valve according to the first embodiment of the present invention is used and a chemical liquid is supplied to the main flow passage and a cleaning liquid is supplied to the secondary flow passage. It is apparent that various methods may be used by various combinations of the opening and closing as the actuators 2 to 5 are independently operable in this embodiment, which means that this valve is very effective. This is also true of the manifold valves according to the second and third embodiments of the present invention.

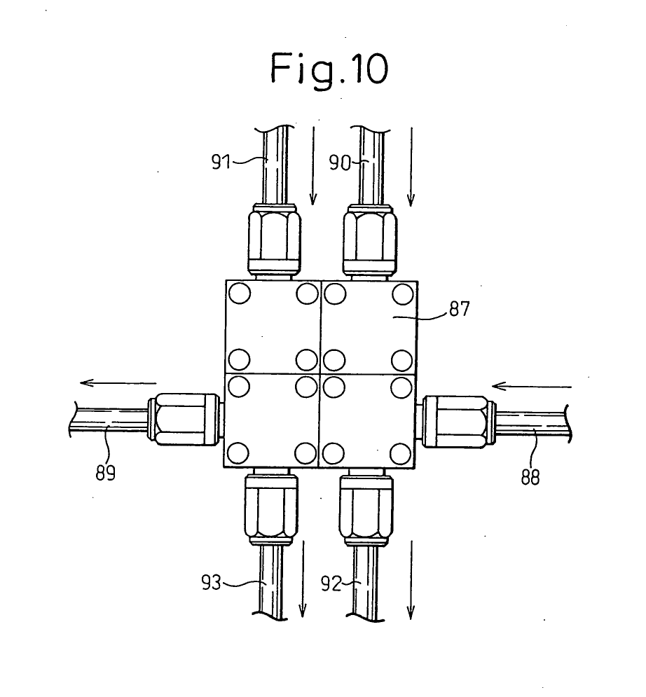

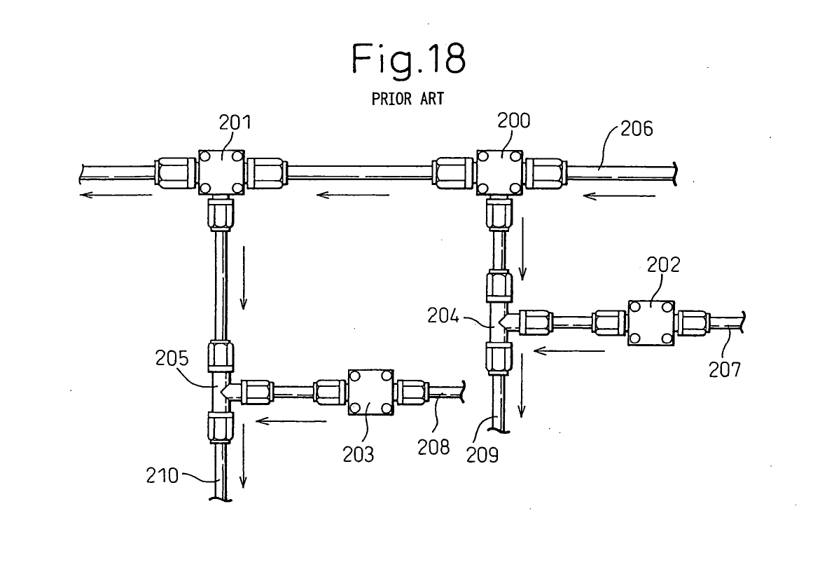

FIG. 10 illustrates an external appearance view of a branched chemical liquid supply line in which the manifold valve according to the first embodiment of the present invention is applied to the above-mentioned prior art. In the drawing, reference numeral 87 designates a manifold valve according to the present invention; reference numerals 88 and 89 designate main flow passages; reference numerals 90 and 91 designate secondary flow passages; and reference numerals 92 and 93 designate branched flow passages, respectively. As can be seen from the drawing, compared with the conventional line shown in FIG. 18, the number of valves and T-shaped pipes can be reduced, i.e., one valve according to this embodiment is sufficient to meet the requirements. Thus, the piping line can be simplified, the piping space can be smaller, and the laying of lines can be easily performed.

While the embodiment of the present invention has been described above in which separate secondary flow passages are formed in correspondence to the respective secondary flow passage-side valve chambers formed in the manifold valve, the present invention should not be limited thereto. For example, as described hereinafter, a plurality of secondary flow passage-side valve chambers may be in communication with the same secondary flow passage through the respective secondary flow passage-side communication ports.

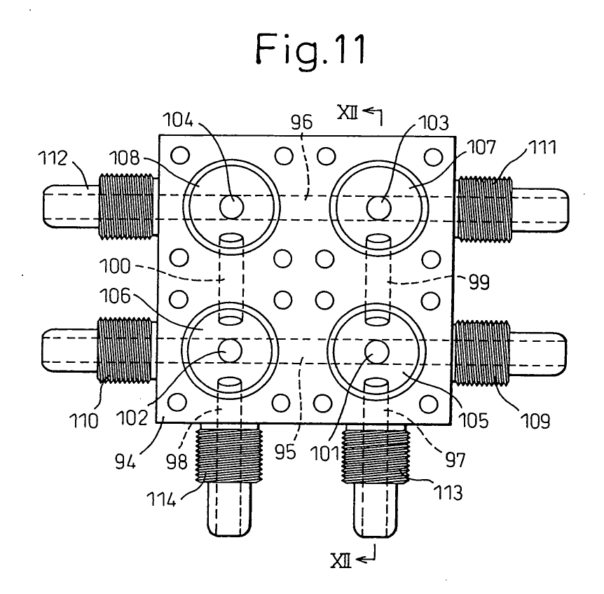

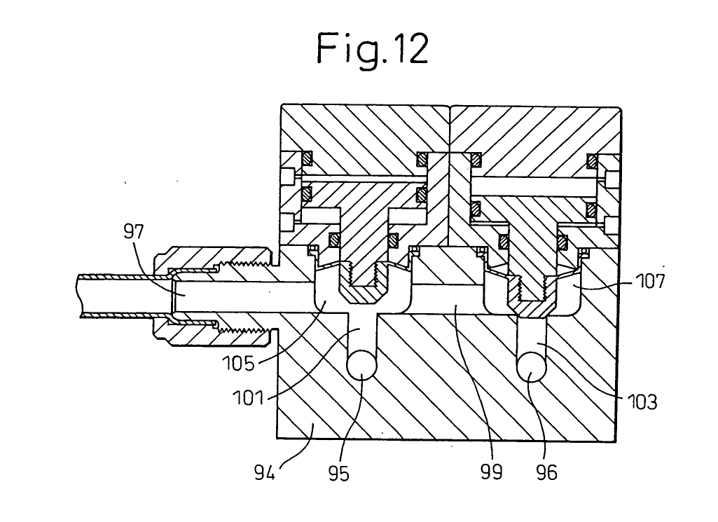

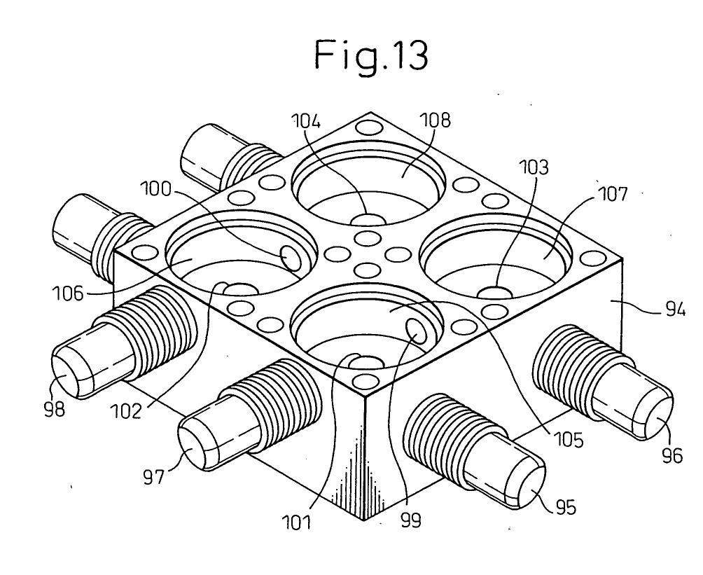

FIG. 11 is a plan view illustrating only a main body 94 of a manifold valve according to a fourth embodiment of the present invention; FIG. 12 is a longitudinal sectional view of the main body taken along a line XII-XII of FIG. 11 with four actuators fixed to the main body; and FIG. 13 is a perspective view of the main body shown in FIG. 11. The difference of the fourth embodiment from the first embodiment is that a secondary flow passage 96 extends parallel to a main flow passage 95 through the main body 94, and two secondary flow passage-side valve chambers 107, 108 communicating with two main flow passage-side valve chambers 105, 106 through connecting flow passages 99, 100, respectively, is in communication with the same secondary flow passage 96 through secondary flow passage-side communication ports 103, 104, respectively. While branched flow passages 97, 98 and the connecting flow passages 99, 100 extend in a direction perpendicular to the main flow passage 95 and the secondary flow passage 96, the other constructions such as main flow passage-side communication ports 101, 102 or coupling portions 109 to 114 are the same as in the first embodiment, and, therefore, a description thereof will be omitted. Also, the operation of the manifold valve according to this embodiment is the same as in the first embodiment except that the cleaning liquid flows from the secondary flow passages 7, 8 to the secondary flow passage-side valve chambers 19, 20 when the secondary flow passage-side communication ports 15, 16 are opened in the manifold valve of the first embodiment, while the cleaning liquid flows from the same secondary flow passage 96 to the respective secondary flow passage-side valve chambers 107, 108 when the secondary flow passage-side communication ports 103, 104 are opened in the manifold valve of this embodiment. Therefore, a description thereof will be omitted.

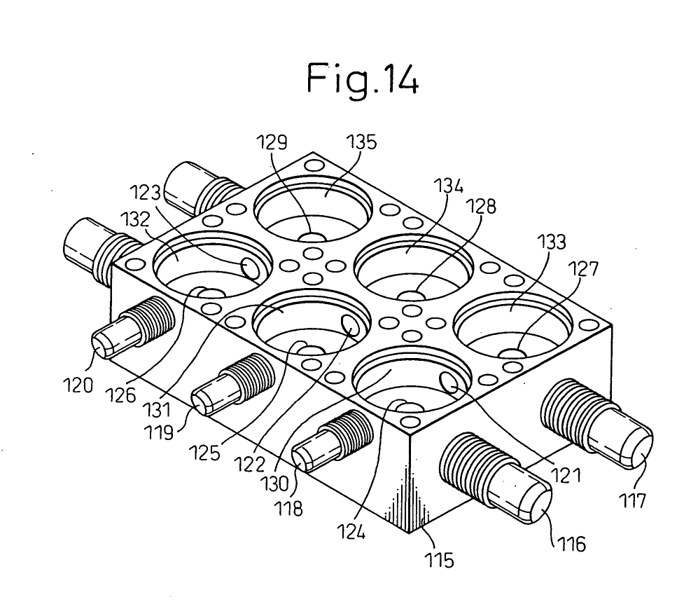

FIG. 14 is a three-dimensional perspective view illustrating only a main body 115 of a manifold valve according to a fifth embodiment of the present invention. The difference thereof from the first embodiment is that three main flow passage-side communication ports 124, 125, 126 are formed in a main flow passage 116 while three secondary flow passage-side communication ports 127, 128, 129 are formed in a secondary flow passage 117, and that there is formed, in correspondence to the respective communication ports, main flow passage-side valve chambers 130, 131, 132, secondary flow passage-side valve chambers 133, 134, 135, branched flow passages 118, 119, 120, and connecting flow passages 121, 122, 123, which are in the same relationship as that of the main flow passage-side valve chamber 17, the secondary flow passage-side valve chamber 19, the branched flow passage 9 and the connecting flow passage 11 relative to the main flow passage-side communication port 13 and the secondary flow passage-side communication port 15 in the first embodiment. Also, the operation thereof is the same as in the fourth embodiment and, therefore, a description thereof will be omitted.

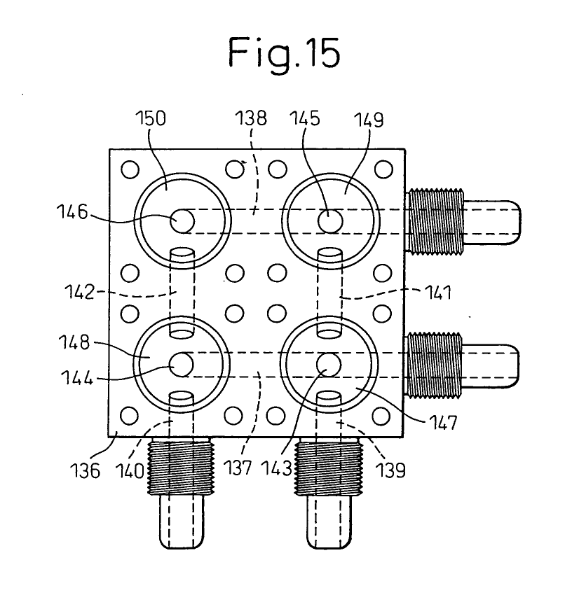

FIG. 15 is a plan view illustrating only a main body 136 of a manifold valve according to a sixth embodiment of the present invention. The difference thereof from the first embodiment is that a main flow passage 137 and a secondary flow passage 138 do not extend through the main body 136 but are opened only on one lateral surface of the main body 136, i.e., one end of each of the main flow passage 137 and the secondary flow passage 138 is opened to the outside of the main body 136 and the other end thereof terminates in the interior of the main body 136. The other constructions such as branched flow passages 139, 140, connecting flow passages 141, 142, main flow passage-side communication ports 143, 144, secondary flow passage-side communication ports 145, 146, main flow passage-side valve chambers 147, 148 or secondary flow passage-side valve chambers 149, 150 are the same as in the manifold valve according to the first embodiment and, therefore, a description thereof will be omitted. Also, the operation thereof is the same as in the fourth embodiment and, therefore, a description thereof will be omitted.

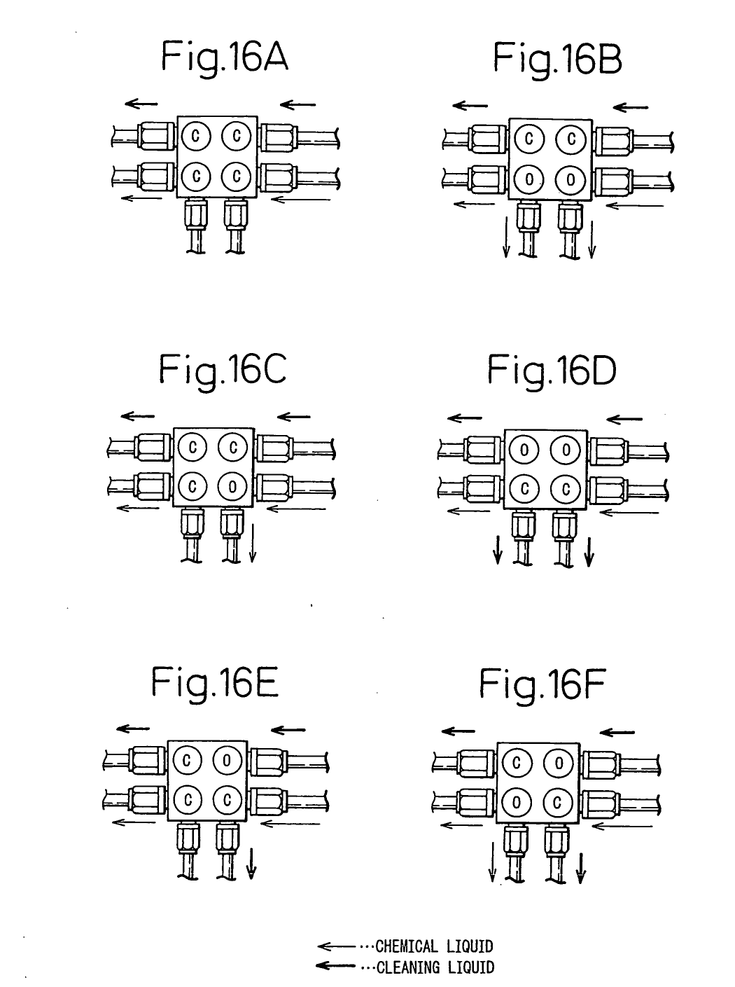

FIGS. 16A to 16F illustrate a representative flow of fluid in the respective combinations of opening and closing of the respective communication ports, wherein the manifold valve according to the fourth embodiment of the present invention is used and a chemical liquid flows in the main flow passage and a cleaning liquid flows in the secondary flow passage. It is apparent that various methods may be used by various combinations of the opening and closing as the actuators 2 to 5 are independently operable in this embodiment, which means that this manifold valve is very effective similar to that shown in FIG. 1. This is also true to the manifold valves according to the fifth and sixth embodiments of the present invention.

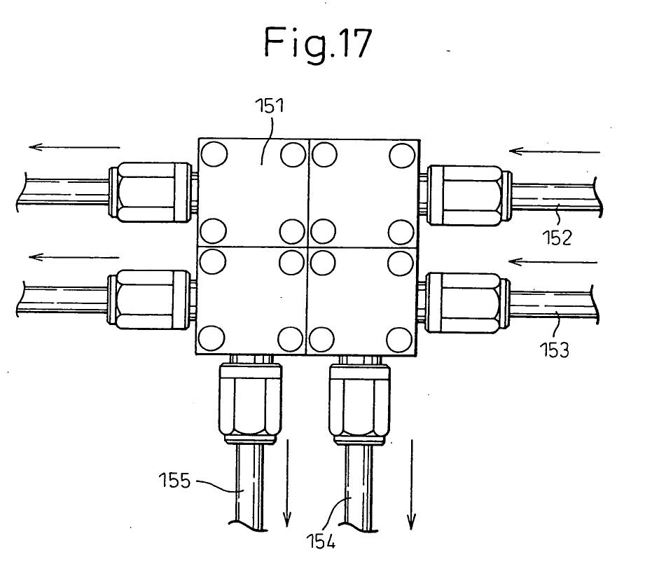

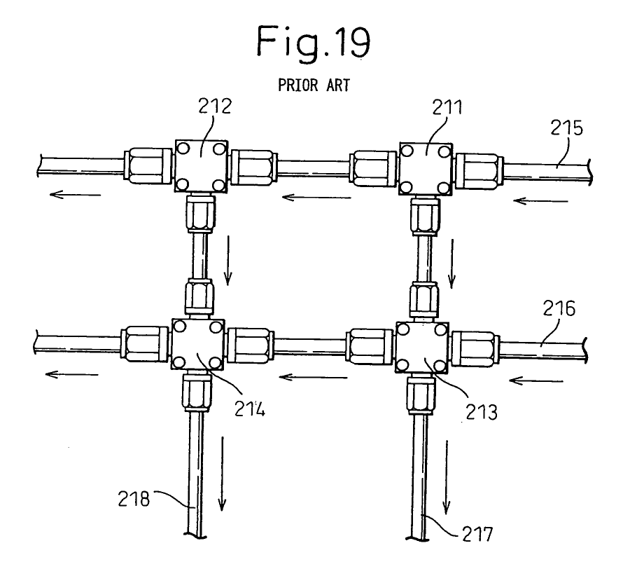

FIG. 17 illustrates an external appearance view of a branched chemical liquid supply line in which the manifold valve according to the fourth embodiment of the present invention is applied to the above-mentioned prior art. In the drawing, reference numeral 151 designates a manifold valve according to the present invention; reference numeral 152 designates a main flow passage; reference numeral 153 designates a secondary flow passage; and reference numerals 154 and 155 designate branched flow passages, respectively. As can be seen from the drawing, comparing with the conventional lines shown in FIGS. 18 and 19, the number of valves and T-shaped pipes can be reduced, i.e., one valve according to this embodiment is sufficient to meet the requirements. Thus, the piping line can be simplified, the piping space can be smaller, and the laying of lines can be easily performed.

The manifold valve according to the present invention has a construction as described above and thus the following superior effects can be achieved by using it.

(a) When the cleaning liquid or the like flows from the secondary flow passage in a condition where the main flow passage-side valve is closed and the secondary flow passage-side valve is opened, the chemical liquid left in the valve chambers can be effectively cleaned and discharged if the secondary flow passage-side valve chamber, the connecting passage, the main flow passage-side valve chamber and the branched flow passage are generally linearly arranged and the bottom surfaces thereof are substantially flush with each other. As a result, the time required for cleaning the flow passages in the valve can be greatly reduced.

(b) When the cleaning liquid flows from the secondary flow passage-side, it is made possible to simultaneously clean the interior of the valve or selectively clean a desired line by the opening and closing operations of a plurality of secondary flow passage-side communication ports formed in the main body.

(c) When the main flow passage and/or the secondary flow passage are formed to extend through the main body, the respective fluids can be retained to flow or circulate even if the main flow passage-side communication port and the secondary flow passage-side communication port are closed. Thus, the manifold valve according to the present invention can be used for fluid having a high sedimentation characteristic, such as a slurry.

(d) As the valve construction is compact, the number of valves or T-shaped pipes in the piping line can be reduced in comparison with the prior art. Thus, the piping line can be simplified, the piping space can be greatly smaller, and the laying of lines can be easily performed.

(e) When fluorocarbon resin such as PTFE or PFA, etc., is used for the materials of the main body and the diaphragm, the chemical resistance is enhanced and the eluation of impurities to the fluid is a little. Thus, the manifold valve according to the present invention can be suitably used for an ultra-pure water line in the semiconductor industry or various chemical liquid lines.

### List of Reference Characters

1 Main body
2 Actuator
3 Actuator
4 Actuator
5 Actuator
6 Main flow passage
7 Secondary flow passage
8 Secondary flow passage
9 Branched flow passage
10 Branched flow passage
11 Connecting flow passage
12 Connecting flow passage
13 Main flow passage-side communication port
14 Main flow passage-side communication port
15 Secondary flow passage-side communication port
16 Secondary flow passage-side communication port
17 Main flow passage-side valve chamber
18 Main flow passage-side valve chamber
19 Secondary flow passage-side valve chamber
20 Secondary flow passage-side valve chamber
21 Valve seat
22 Valve seat
23 Valve seat
24 Valve seat
25 Coupling portion
26 Coupling portion
27 Coupling portion
28 Coupling portion
29 Coupling portion
30 Coupling portion
31 Cap nut
32 Cap nut
33 Cap nut
34 Cap nut
35 Cap nut
36 Cap nut
37 Piping tube
38 Piping tube
39 Piping tube
40 Piping tube
41 Piping tube
42 Piping tube
43 Male thread portion
44 Forward end portion
45 Female thread portion
46 Valve body
47 Valve body
48 Valve body
49 Valve body
50 Cylinder body
51 Cylinder cap
52 Piston
53 Diaphragm
54 Cylinder portion
55 Protrusion
56 Through hole
57 Columnar protrusion
58 Rod portion
59 Joining portion
60 Cylindrical membrane portion
61 Annular projection
62 Upper gap
63 Lower gap
64 Working fluid supply port
65 Working fluid supply port
66 Stepped portion
67 O-ring
68 O-ring
69 O-ring
70 O-ring
71 Main body
72 Main flow passage
73 Secondary flow passage
74 Secondary flow passage
75 Branched flow passage
76 Branched flow passage
77 Connecting flow passage
78 Connecting flow passage
79 Main body
80 Main flow passage
81 Secondary flow passage
82 Secondary flow passage
83 Branched flow passage
84 Branched flow passage
85 Connecting flow passage
86 Connecting flow passage
87 Manifold Valve
88 Main flow passage
89 Main flow passage
90 Secondary flow passage
91 Secondary flow passage
92 Branched flow passage
93 Branched flow passage
94 Main body
95 Main flow passage
96 Secondary flow passage
97 Branched flow passage
98 Branched flow passage
99 Connecting flow passage
100 Connecting flow passage
101 Main flow passage-side communication port
102 Main flow passage-side communication port
103 Secondary flow passage-side communication port
104 Secondary flow passage-side communication port
105 Main flow passage-side valve chamber
106 Main flow passage-side valve chamber
107 Secondary flow passage-side valve chamber
108 Secondary flow passage-side valve chamber
109 Coupling portion
110 Coupling portion
111 Coupling portion
112 Coupling portion
113 Coupling portion
114 Coupling portion
115 Main body
116 Main flow passage
117 Secondary flow passage
118 Branched flow passage
119 Branched flow passage
120 Branched flow passage
121 Connecting flow passage
122 Connecting flow passage
123 Connecting flow passage
124 Main flow passage-side communication port
125 Main flow passage-side communication port
126 Main flow passage-side communication port
127 Secondary flow passage-side communication port
128 Secondary flow passage-side communication port
129 Secondary flow passage-side communication port
130 Main flow passage-side valve chamber
131 Main flow passage-side valve chamber
132 Main flow passage-side valve chamber
133 Secondary flow passage-side valve chamber
134 Secondary flow passage-side valve chamber
135 Secondary flow passage-side valve chamber
136 Main body
137 Main flow passage
138 Secondary flow passage
139 Branched flow passage
140 Branched flow passage
141 Connecting flow passage
142 Connecting flow passage
143 Main flow passage-side communication port
144 Main flow passage-side communication port
145 Secondary flow passage-side communication port
146 Secondary flow passage-side communication port
147 Main flow passage-side valve chamber
148 Main flow passage-side-valve chamber
149 Secondary flow passage-side valve chamber
150 Secondary flow passage-side valve chamber
151 Manifold valve
152 Main flow passage
153 Secondary flow passage
154 Branched flow passage
155 Branched flow passage
200 Three way valve
201 Three way valve
202 Four way valve
203 Four way valve
204 T-shaped pipe
205 T-shaped pipe
206 Main flow passage
207 Secondary flow passage
208 Secondary flow passage
209 Branched flow passage
210 Branched flow passage
211 Three way valve
212 Three way valve
213 Four way valve
214 Four way valve
215 Main flow passage
216 Secondary flow passage
217 Branched flow passage
218 Branched flow passage

1. A manifold valve comprising:
a main body;
actuators each having a valve body;
said main body formed with at least one set of a main flow passage-side valve chamber and a secondary flow passage-side valve chamber which are in communication with each other through a connecting flow passage, a branched flow passage communicating with said main flow passage-side valve chamber, a main flow passage communicating with said main flow passage-side valve chamber through a main flow passage-side communication port opening at a center of a bottom of said main flow passage-side valve chamber, and a secondary flow passage communicating with said secondary flow passage-side valve chamber through a secondary flow passage-side-communication port opening at a center of a bottom of said secondary flow passage-side valve chamber;
said main flow passage-side communication port and said secondary flow passage-side communication port being opened and closed by said valve bodies of said actuators, respectively; and
said connecting flow passage and said branched flow passage being structured such that bottoms thereof are substantially flush with the bottoms of said main flow passage-side valve chamber and said secondary flow passage-side valve chamber.

2. The manifold valve according to claim 1, wherein said manifold valve is formed with a plurality of main flow passage-side valve chambers, said plurality of main flow passage-side valve chambers communicating with the same main flow passage through respective main flow passage-side communication ports.

3. The manifold valve according to claim 1, wherein said manifold valve is formed with a plurality of secondary flow passage-side valve chambers, said plurality of secondary flow passage-side valve chambers communicating with different secondary flow passages through respective secondary flow passage-side communication ports thereof.

4. The manifold valve according to claim 1, wherein said manifold valve is formed with a plurality of secondary flow passage-side valve chambers, said plurality of secondary flow passage-side valve chambers communicating with the same secondary flow passage through respective secondary flow passage-side communication ports thereof.

5. The manifold valve according to claim 1, wherein said main flow passage extends parallel to said secondary flow passage.

6. The manifold valve according to claim 1, wherein said main flow passage extends perpendicular to said secondary flow passage.

7. The manifold valve according to claim 1, wherein said main flow passage extends through said main body.

8. The manifold valve according to claim 1, wherein said main flow passage opens, at one end thereof, to the outside and terminates, at the other end thereof, in the interior of said main body.

9. The manifold valve according to claim 1, wherein said secondary flow passage extends through said main body.

10. The manifold valve according to claim 1, wherein said secondary flow passage opens, at one end thereof, to the outside and terminates, at the other end thereof, in the interior of said main body.
